(19) United States
(12) Patent Application Publication
(10) Pub. No.: US 2023/0306855 A1
(43) Pub. Date: Sep. 28, 2023

(54) CENTRALIZED MANAGEMENT SYSTEM FOR UNMANNED AERIAL VEHICLE AND CENTRALIZED MANAGEMENT METHOD FOR UNMANNED AERIAL VEHICLE

(71) Applicant: NEC Corporation, Tokyo (JP)

(72) Inventors: Tetsuya Tanabiki, Tokyo (JP); Takuya Nomura, Tokyo (JP); Takuya Hisamoto, Tokyo (JP); Kenichi Kijima, Tokyo (JP); Eiichi Tokumi, Tokyo (JP); Takahiro Mizuta, Tokyo (JP)

(73) Assignee: NEC Corporation, Tokyo (JP)

(21) Appl. No.: 18/197,474

(22) Filed: May 15, 2023

(30) Foreign Application Priority Data
Feb. 2, 2022 (JP) 2022-081295

(51) Int. Cl. G08G 5/00

(52) U.S. Cl. CPC G08G 5/0039; G08G 5/0043; G08G 5/0069

(57) ABSTRACT

A centralized management system for an unmanned aerial vehicle includes a centralized management device and an information communication device. The information communication device is attached to an unmanned aerial vehicle to be monitored, acquires flight status information indicating a flight status of the unmanned aerial vehicle from the unmanned aerial vehicle to transmit the acquired flight status information in a predetermined data format by wireless communication. The centralized management device monitors the unmanned aerial vehicle using flight status information transmitted from the information communication device.

This application is based upon and claims the benefit of priority from Japanese Patent Application No. 2022-81295, filed on May 18, 2022, the disclosure of which is incorporated herein in its entirety by reference.

### TECHNICAL FIELD

The present invention relates to a technique for centrally managing flights of a plurality of unmanned aerial vehicles.

### BACKGROUND ART

Efforts have been made by the country to achieve a beyond-visual flight of the unmanned aerial vehicle. The unmanned aerial vehicle herein is an airplane, a rotorcraft, a glider, an airship, or the like that can be used for aviation, and can be flown by remote control or automatic control. Such an unmanned aerial vehicle is also referred to as a drone, an UAV, or the like. When the beyond-visual flight of the unmanned aerial vehicle can be achieved, a utilization range of the unmanned aerial vehicle is widened, and thus utilization of the unmanned aerial vehicle is expected in distribution, infrastructure inspection, and the like.

Reference Literature 1 (JP 2018-165932 A) discloses a technique of creating a flight plan for each drone, and receiving state information including a current position sequentially transmitted from a flying drone to manage the dynamics of the flying drone.

### SUMMARY

An object of the present invention is to provide a technique for preventing complication of processing related to information acquisition from each unmanned aerial vehicle even in a case where flight management of a plurality of types of unmanned aerial vehicles different from each other is performed.

An aspect of a centralized management system for an unmanned aerial vehicle according to the present invention includes
an information communication device that is attached to an unmanned aerial vehicle to be monitored, acquires flight status information indicating a flight status of the unmanned aerial vehicle from the unmanned aerial vehicle, and transmits the acquired flight status information in a predetermined data format by wireless communication, and
a centralized management device that monitors the unmanned aerial vehicle using the flight status information transmitted from the information communication device.

An aspect of a centralized management method for an unmanned aerial vehicle according to the present invention includes
an information communication device that is attached to an unmanned aerial vehicle to be monitored acquiring flight status information indicating a flight status of the unmanned aerial vehicle from the unmanned aerial vehicle, and
transmitting the acquired flight status information in a predetermined data format by wireless communication, and
a centralized management device that monitors the unmanned aerial vehicle monitoring the unmanned aerial vehicle using the flight status information transmitted from the information communication device.

### BRIEF DESCRIPTION OF THE DRAWINGS

Exemplary features and advantages of the present invention will become apparent from the following detailed description when taken with the accompanying drawings in which:

FIG. 1 is an image diagram illustrating a centralized management system for an unmanned aerial vehicle according to the first example embodiment of the present invention;

FIG. 2 is a diagram for explaining a configuration of a centralized management system for an unmanned aerial vehicle according to the first example embodiment;

FIG. 3 is a diagram for explaining a configuration of a centralized management system for an unmanned aerial vehicle according to another example embodiment; and

FIG. 4 is a diagram for explaining a configuration of a centralized management system for an unmanned aerial vehicle according to still another example embodiment.

### EXAMPLE EMBODIMENT

Hereinafter, an example embodiment according to the present invention will be described with reference to the drawings.

First, the background to the example embodiment described below will be described.

That is, when a system such as distribution is operated by utilizing a plurality of unmanned aerial vehicles, it is conceivable that a plurality of types of unmanned aerial vehicles of different manufacturers and types and a plurality of unmanned aerial vehicles of different owners are mixed in the same system. In such a case, since it is considered that the control method of the unmanned aerial vehicles are different depending on the type and the owner, it is considered that the centralized management of the unmanned aerial vehicles is complicated.

The flight control of the unmanned aerial vehicle is performed by a ground device also referred to as a ground control station (GCS) or a ground station. That is, the ground device can wirelessly communicate with the unmanned aerial vehicle, transmits a take-off instruction to the unmanned aerial vehicle, and receives data of a sensor or a camera mounted on the unmanned aerial vehicle and position information using a global navigation satellite system (GNSS) from the unmanned aerial vehicle. The ground device transmits an instruction (control signal) to the unmanned aerial vehicle in such a way that the unmanned aerial vehicle can be operated according to a flight plan given in advance using the data of the sensor, the image of the camera, and the position information received from the unmanned aerial vehicle, and performs flight control of the flying unmanned aerial vehicle. Such a ground device is related to each unmanned aerial vehicle, and a communication process for performing wireless communication between the ground device and the unmanned aerial vehicle, a type and a format of information (data) communicated between the ground device and the unmanned aerial vehicle, and the like vary depending on a type of the unmanned aerial vehicle, specifications required from an owner, and the like.

For this reason, when it is attempted to centrally manage flights of a plurality of unmanned aerial vehicles of different types, the following problems occur. That is, when information communicated between the ground device and the unmanned aerial vehicle is acquired to be used for centralized management of the unmanned aerial vehicle, and information necessary for flight management is extracted from the acquired information, it is necessary to perform extraction processing different for each data format of the information. Therefore, processing related to information acquisition is complicated. In a case where a new type of unmanned aerial vehicle is to be centrally managed, it is necessary to be able to execute processing of extracting information related to the new type of unmanned aerial vehicle, which is troublesome. Therefore, in the following example embodiment, there is provided a technique for preventing complication of processing related to information acquisition from each unmanned aerial vehicle even in a case where flight management of a plurality of types of unmanned aerial vehicles different from each other is performed.

### First Example Embodiment

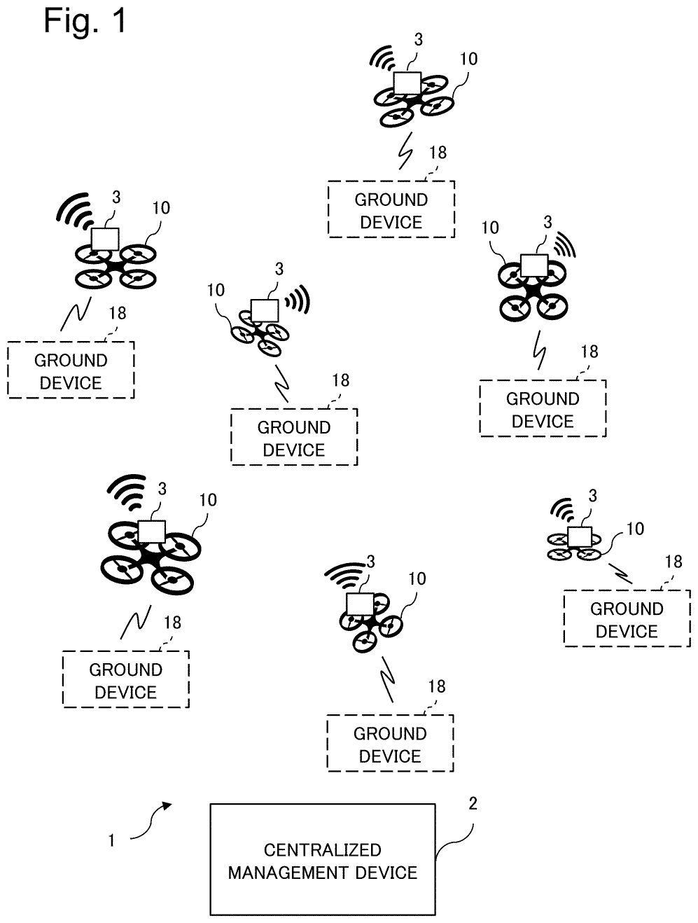

FIG. 1 is an image diagram illustrating a configuration of a centralized management system for an unmanned aerial vehicle according to the first example embodiment of the present invention. A centralized management system 1 for unmanned aerial vehicles (hereinafter, also referred to as a centralized management system 1 for short) according to the first example embodiment is a system that monitors a plurality of unmanned aerial vehicles 10 and centrally manages flights of the unmanned aerial vehicles 10, and includes a centralized management device 2 and an information communication device 3. The unmanned aerial vehicle 10 can be used for aviation and can be flown by remote control or automatic control, and includes so-called drones and flying vehicles.

Even when a plurality of types of unmanned aerial vehicles 10 is included as monitoring and management targets, the centralized management system 1 of the first example embodiment can acquire information from the unmanned aerial vehicle 10 without performing complicated processing of acquiring information necessary for monitoring and flight management by performing information processing different for each type of unmanned aerial vehicle 10. That is, in the centralized management system 1, the information communication device 3 is attached to the unmanned aerial vehicle 10 to be monitored and managed (hereinafter, it is simply referred to as a management target). The information communication device 3 is an attachment, and can achieve information communication between the unmanned aerial vehicle 10 and the centralized management device 2 without troublesome labor by being attached to the unmanned aerial vehicle 10.

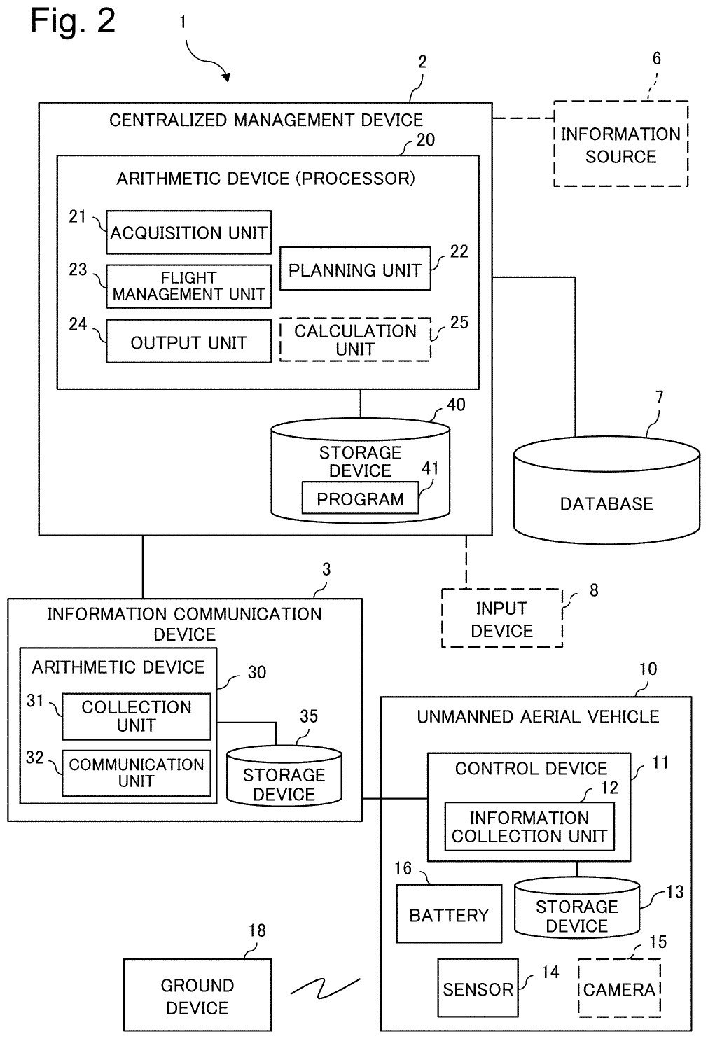

FIG. 2 is a diagram illustrating configurations of the centralized management device 2 and the information communication device 3 constituting the centralized management system 1 according to the first example embodiment. The centralized management device 2 is connected to the information communication device 3 by wireless communication, for example, via an information communication network of a mobile terminal. In a case where there is a plurality of unmanned aerial vehicles 10 managed by the centralized management system 1, the information communication device 3 is attached to each of the unmanned aerial vehicles 10, and the information communication device 3 is connected to the centralized management device 2 by wireless communication. Even when the types of the unmanned aerial vehicles 10 are different, the configuration of the information communication device 3 attached to the unmanned aerial vehicle 10 is similar, and thus, only one information communication device 3 is illustrated in FIG. 2.

A control configuration of the unmanned aerial vehicle 10 will be described. The unmanned aerial vehicle 10 includes a control device 11 and a storage device 13 as a configuration related to motion control of the unmanned aerial vehicle 10. The storage device 13 includes a storage medium that stores a computer program (hereinafter, also referred to as a program) and data (information). The storage device 13 stores, for example, aircraft information representing its own aircraft (unmanned aerial vehicle 10). Examples of the aircraft information include aircraft identification information for identifying an airframe, information indicating a manufacturer, information indicating an administrator, performance information including information about a maximum loading amount, a maximum speed, and a maximum battery storage amount, maintenance and inspection records of its own aircraft (unmanned aerial vehicle 10), and the like.

The control device 11 includes, for example, a processor such as a central processing unit (CPU), and can have a function based on a program stored in the storage device 13 by executing the program. For example, the control device 11 includes an information collection unit 12 as a function unit. The information collection unit 12 collects flight status information indicating a flight status of the unmanned aerial vehicle 10. One of the flight status information is position information indicating the position of the unmanned aerial vehicle 10. That is, the information collection unit 12 calculates the position of the unmanned aerial vehicle 10 using, for example, a global navigation satellite system (GNSS). The information collection unit 12 acquires the remaining battery level of the unmanned aerial vehicle 10 from a battery 16 as flight status information. Furthermore, the information collection unit 12 acquires sensor output as flight status information. The sensor output is output from a sensor 14 included in the unmanned aerial vehicle 10. In a case where the unmanned aerial vehicle 10 includes a camera 15, data of the captured image captured by the camera 15 is acquired as the flight status information. Such information collection by the information collection unit 12 is executed, for example, at a predetermined timing. The number of sensors 14 mounted on the unmanned aerial vehicle 10 is not limited to one, and may be plural. In this case, the information collection unit 12 acquires sensor outputs of the plurality of sensors 14 as flight status information.

The unmanned aerial vehicle 10 is connected to a ground device 18, which is also referred to as a ground control station (GCS) or a ground station, by wireless communication, and can exchange information with the ground device 18. The control device 11 transmits the information acquired by the information collection unit 12 to the ground device 18 at preset timings during flight, for example. The ground device 18 receives information transmitted from the unmanned aerial vehicle 10, generates an instruction for flight control of the unmanned aerial vehicle 10 using the received information and a flight plan given in advance, and transmits the generated instruction to the unmanned aerial vehicle 10. The control device 11 of the unmanned aerial vehicle 10 controls the flight operation according to the instruction received from the ground device 18. In this manner, the flight of the unmanned aerial vehicle 10 is controlled by the ground device 18. There are various methods for the ground device 18 to control the flight of the unmanned aerial vehicle 10. In other words, there are various types of computer programs by which the ground device 18 controls the flight of the unmanned aerial vehicle 10. The computer program mounted on the ground device 18 is an appropriate type of computer program in consideration of the structure of the related unmanned aerial vehicle 10 and the like. That is, the same type of computer program is not necessarily mounted on the ground device 18 related to each of the plurality of unmanned aerial vehicles 10 to be managed in the centralized management system 1. Even when the same type of computer program is implemented in some ground devices 18, the computer program is often customized according to the unmanned aerial vehicle 10 to be controlled. Therefore, types, formats, and the like of information (data) communicated between the ground device 18 and the unmanned aerial vehicle 10 vary.

As described above, the information communication device 3 is attached to the unmanned aerial vehicle 10 and connected to the control device 11 of the unmanned aerial vehicle 10. The information communication device 3 includes an arithmetic device 30 and a storage device 35. The storage device 35 includes a storage medium that stores programs and data (information), and stores, for example, aircraft information representing the unmanned aerial vehicle 10 in which the information communication device 3 is mounted. This aircraft information is information similar to the aircraft information stored in the storage device 13 of the unmanned aerial vehicle 10, and includes, for example, aircraft identification information for identifying an airframe, information indicating a manufacturer, information indicating an administrator, performance information about the aircraft including information about a maximum loading amount, a maximum speed, and a maximum battery storage amount, maintenance and inspection records, and the like. There are many types of storage devices. For example, there is a semiconductor memory device as one of the storage devices, and the semiconductor memory device includes a plurality of types such as a random access memory (RAM) and a read only memory (ROM). The number of the types of the storage device 35 included in the information communication device 3 is not limited to one, and the type and the number of the storage devices 35 included in the information communication device 3 are not limited, and the description thereof will be omitted. In a case where the information communication device 3 includes a plurality of types of storage devices 35, they are collectively referred to as a storage device 35.

The arithmetic device 30 includes a processor such as a CPU, and can have a function based on a program stored in the storage device 35 by executing the program. The arithmetic device 30 includes a collection unit 31 and a communication unit 32 as function units. The collection unit 31 acquires information to be collected predetermined in advance from control device 11 of the unmanned aerial vehicle 10 at a predetermined timing (for example, for each set time interval). The information to be collected here is information to be transmitted to the centralized management device 2, and is information used by the centralized management device 2 to perform flight management of the unmanned aerial vehicle 10. The information to be collected includes at least flight status information indicating a flight status of the unmanned aerial vehicle 10. Examples of the flight status information include position information indicating a position of the unmanned aerial vehicle 10, remaining battery level information indicating a remaining level (that is, the storage amount) of battery 16, sensor output information indicating a sensor output of the sensor 14, a captured image, and the like. Time information indicating calculated or acquired time, such as time information indicating time when the position is calculated, is associated with the information to be collected. The type of information acquired by the collection unit 31 from the unmanned aerial vehicle 10 may be the same as or different from the type of information communicated between the unmanned aerial vehicle 10 and the ground device 18.

The communication unit 32 transmits the aircraft information stored in the storage device 35 by wireless communication. The timing of transmitting the aircraft information is, for example, a preset timing such as when requested from the centralized management device 2 or when the communication with the centralized management device 2 is the first time.

The communication unit 32 transmits the information collected by the collection unit 31 by wireless communication, for example, every time the information is collected. The information transmitted by the communication unit 32 is associated with aircraft identification information about the attached unmanned aerial vehicle 10. The information to be transmitted has a predetermined data format.

That is, the information communication device 3 transmits information about a predetermined type in a predetermined data format regardless of the type of the unmanned aerial vehicle 10 mounted. As a result, even when a plurality of unmanned aerial vehicles 10 of different types is included as the management targets of the centralized management system 1, the centralized management device 2 can receive the same type of information in the same data format from each unmanned aerial vehicle 10 via the attached information communication device 3. That is, the information communication device 3 can be an interface device that connects the unmanned aerial vehicle 10 and the centralized management device 2 in order to transmit information from the unmanned aerial vehicle 10 to the centralized management device 2.

The aircraft information in the storage device 35 is stored, for example, in the operation side that operates the centralized management system 1 before the information communication device 3 is attached to the unmanned aerial vehicle 10. Alternatively, at an appropriate timing after the information communication device 3 is attached to the unmanned aerial vehicle 10 and connected to the control device 11 of the unmanned aerial vehicle 10, the collection unit 31 may acquire the information from the storage device 13 via the control device 11 of the unmanned aerial vehicle 10 and write the information in the storage device 35. Since the collection unit 31 has such a function, the convenience of the information communication device 3 can be enhanced. It is assumed that there is a case where the information communication device 3 attached to the unmanned aerial vehicle 10 is attached to another unmanned aerial vehicle 10. In such a case, it is necessary to change the aircraft information stored in the storage device 35 of the information communication device 3 to the aircraft information about another unmanned aerial vehicle 10. When the collection unit 31 has a function of acquiring aircraft information from the unmanned aerial vehicle 10, it is not necessary to manually change the aircraft information in the storage device 35 of the information communication device 3.

The centralized management device 2 is a computer device (server), and performs flight management including monitoring of the unmanned aerial vehicle 10 using information about the unmanned aerial vehicle 10 transmitted from the information communication device 3. In the first example embodiment, the configuration of the centralized management device 2 will be described by taking as an example a case where flight management of the unmanned aerial vehicle 10 constructing the distribution system is performed.

The centralized management device 2 includes an arithmetic device 20 and a storage device 40. The storage device 40 includes a storage medium that stores data and a program 41. There is a plurality of types of storage devices such as a magnetic disk device and a semiconductor memory device, and there is a plurality of types of semiconductor memory devices such as a random access memory (RAM) and a read only memory (ROM) as described above. The number of the types of the storage device 40 included in the centralized management device 2 is not limited to one. A computer device is often provided with a plurality of types of storage devices. The type and the number of the storage devices 40 provided in the centralized management device 2 are not limited, and the description thereof will be omitted. In a case where the centralized management device 2 includes a plurality of types of storage devices 40, they are collectively referred to as a storage device 40. It is conceivable that the centralized management device 2 is connected to a database 7, which is an external storage device, and reads and writes data and the like from and to the database 7. However, here, even when data and the like are read and written from and to the database 7, the description thereof will be omitted.

The storage device 40 stores a program for causing the centralized management device 2 to have a function of performing flight management of the unmanned aerial vehicle 10.

The arithmetic device 20 includes a processor such as a central processing unit (CPU) or a graphics processing unit (GPU). The arithmetic device 20 can have various functions based on the program 41 by reading and executing the program 41 stored in the storage device 40. The arithmetic device 20 includes an acquisition unit 21, a planning unit 22, a flight management unit 23, and an output unit 24 as function units related to flight management of the unmanned aerial vehicle 10.

The planning unit 22 generates a flight plan of the unmanned aerial vehicle 10 to be managed. The unmanned aerial vehicle 10 to be managed is involved in logistics and is responsible for transporting (delivering) an article to a destination. For example, the planning unit 22 assigns one or a plurality of articles to be transported to each of the unmanned aerial vehicles 10 to be managed for each day. The assignment of the article to be transported is calculated using information such as the size and weight of the article to be transported, the place (address) of the transport destination (delivery destination), and the maximum loading amount of the unmanned aerial vehicle 10. There are various methods for calculating the assignment of the article to be transported, and here, the method is not limited, and the description of the method is omitted. The user of the centralized management device 2 inputs information about the article to be transported (for example, information about the size and weight of the article, information about the date of transportation, and the like) to the centralized management device 2 using the input device 8 with which the information is input. Alternatively, the information about the article to be transported may be provided from an information source 6, which is another computer device (server) holding the information, to the centralized management device 2. The method by which the information about the article to be transported is input (provided) to the centralized management device 2 may be either manual input or provision from another computer device, or both.

The planning unit 22 generates a flight plan for the unmanned aerial vehicle 10 to transport (deliver) the article to be transported assigned as described above, for example, for each day. That is, when there is a plurality of articles to be transported in one day for each unmanned aerial vehicle 10, the planning unit 22 calculates the order of transporting the articles in that day. The planning unit 22 calculates a flight route for transporting the articles to be transported in the determined order. Furthermore, in a case where it is necessary to charge the battery 16 of the unmanned aerial vehicle 10 during the transport work in one day, the planning unit 22 calculates the flight route including the charging place and time. The method of calculating the transporting order of the plurality of articles to be transported, the method of calculating the flight route, and various pieces of information used when calculating the transporting order and the flight route are not limited herein, and the description thereof will be omitted.

The planning unit 22 generates, for each unmanned aerial vehicle 10, a daily flight plan including information indicating the assigned article to be transported and information about the flight route calculated for transporting the article. Then, the planning unit 22 stores the generated flight plan in the storage device 40 (database 7). The stored flight plan is associated with aircraft identification information about the related unmanned aerial vehicle 10 and information about a scheduled execution date of the plan.

The planning unit 22 may change (update) the flight plan of the unmanned aerial vehicle 10 to be managed as follows. That is, while the unmanned aerial vehicle 10 is executing the transport work according to the flight plan, an article to be transported may be added by, for example, pickup, express delivery, or the like. In this case, the planning unit 22 changes (updates) the flight plan of the unmanned aerial vehicle 10 to be managed by allocating the added article to be transported, changing the allocation of the article to be transported, or the like in consideration of the availability of the unmanned aerial vehicle 10 to be managed. In this way, when the flight plan is changed, the flight plan stored in the storage device 40 (database 7) is updated by the planning unit 22.

The output unit 24 outputs information to a predetermined transmission destination of the information. For example, the output unit 24 outputs the flight plan planned by the planning unit 22 to the ground device 18 that performs flight control of the unmanned aerial vehicle 10 scheduled to fly in the flight plan. In such a case, information indicating a correspondence relationship between the unmanned aerial vehicle 10 to be managed and the ground device 18 that performs flight control of the unmanned aerial vehicle 10, and address information for transmitting the information to the ground device 18 are held in the storage device 40 or the database 7.

The acquisition unit 21 acquires information (management information) transmitted from each of the unmanned aerial vehicles 10 to be managed via the information communication device 3. The acquired information is classified for each unmanned aerial vehicle 10 (in other words, the aircraft identification information) and stored in the storage device 40. That is, the information (dynamic information) momentarily transmitted from each unmanned aerial vehicle 10 to be managed via the information communication device 3 is stored in the storage device 40 in association with the aircraft identification information as the status history information indicating the history of the status of the unmanned aerial vehicle 10 to be managed.

In a case where the centralized management device 2 is connected to the following information source 6, the acquisition unit 21 acquires information from the connected information source 6. That is, as an example of the information source 6 to which the centralized management device 2 is connected, there is a computer device as an information source that provides weather information. In a case where the centralized management device 2 is connected to the information source of such weather information, for example, the acquisition unit 21 acquires, as airspace information, weather information about the airspace in which the unmanned aerial vehicle 10 to be managed flies from the information source of the weather information at preset time intervals. In a case where the centralized management device 2 can acquire weather information in this manner, for example, the planning unit 22 can utilize the weather information (weather forecast information) such as calculating a flight route avoiding an airspace where wind is assumed to be strong when calculating the flight route. In a case where the centralized management device 2 acquires information related to flight other than weather information, the planning unit 22 may calculate a flight route by utilizing the acquired information instead of the weather information or by utilizing the weather information and the acquired information.

Furthermore, as another example of the information source 6 to which the centralized management device 2 is connected, there is a computer device as an information source that provides information about the flight status of a manned aircraft (hereinafter, also referred to as an emergency helicopter) flying in an emergency such as an emergency medical helicopter or a fire and disaster prevention helicopter. When the centralized management device 2 can be connected to the information source of the emergency information about the flight of the emergency helicopter, the acquisition unit 21 acquires, as airspace information, the information about the flight status of the emergency helicopter in the airspace in which the unmanned aerial vehicle 10 to be managed flies from the information source of the emergency information. For example, in a case where information making notification that an emergency helicopter will urgently fly in an airspace where the unmanned aerial vehicle 10 to be managed flies is transmitted from an information source of the emergency information, the acquisition unit 21 acquires the information. The centralized management device 2 may be connected to a plurality of information sources 6.

The flight management unit 23 manages the flight of the unmanned aerial vehicle 10 to be managed. For example, for each of the unmanned aerial vehicles 10 to be managed, the flight management unit 23 compares the position information acquired by the acquisition unit 21 and the time information associated with the position information with the flight plan planned by the planning unit 22, and monitors whether the unmanned aerial vehicle 10 to be managed is flying according to the flight plan. For example, in a case where the flight management unit 23 detects the unmanned aerial vehicle 10 flying out of the allowable range from the flight route (hereinafter, also referred to as a planned route) planned by the flight plan by the monitoring, the flight management unit executes a predetermined handling process. As the handling process, for example, the flight management unit 23 notifies, by the output unit 24, the ground device 18 performing flight control of the unmanned aerial vehicle 10 deviating from the planned route of information indicating the deviation from the planned route. As a result, for example, the trajectory of the unmanned aerial vehicle 10 is corrected to the planned route by the flight control of the ground device 18. The flight management unit 23 may execute the following processing when detecting the unmanned aerial vehicle 10 deviating from the planned route. That is, the flight management unit 23 uses the position information about the unmanned aerial vehicle 10 to detect the unmanned aerial vehicle 10 flying around the unmanned aerial vehicle 10 deviating from the planned route. Then, the flight management unit 23 changes the flight route (planned route) of the detected unmanned aerial vehicle 10 so as not to collide with the unmanned aerial vehicle 10 deviating from the planned route to output the changed (updated) flight plan to the related ground device 18. By receiving the updated flight plan, the ground device 18 performs flight control of the unmanned aerial vehicle 10 according to the updated flight plan. The flight management unit 23 may execute the processing described above, and when there is the unmanned aerial vehicle 10 that deviates from the planned route, the collision with another unmanned aerial vehicle 10 flying around the unmanned aerial vehicle can be avoided by executing the processing.

In a case where the flight management unit 23 detects the unmanned aerial vehicle 10 whose transport process is significantly delayed beyond the allowable delay time compared to the flight plan by monitoring the unmanned aerial vehicle 10 to be managed, for example, the following handling process is executed. The handling process is, for example, a process of allocating at least one of the delayed articles scheduled to be transported by the unmanned aerial vehicle 10 to another unmanned aerial vehicle 10. Then, the flight management unit 23 causes the planning unit 22 to correct the delayed flight plan of the unmanned aerial vehicle 10 and the flight plan of the unmanned aerial vehicle 10 to which the article to be transported has been newly allocated, and updates the flight plan. The updated flight plan is transmitted by the output unit 24 to the related ground device 18. The ground device 18 that has received the updated flight plan performs flight control of the unmanned aerial vehicle 10 according to the updated flight plan.

When the flight management unit 23 detects, by monitoring the unmanned aerial vehicle 10 to be managed, the unmanned aerial vehicle 10 whose transport process is in progress earlier than the flight plan by a set time or more, for example, the flight plan of the unmanned aerial vehicle 10 is corrected by the planning unit 22 and the flight plan is updated. The flight plan thus updated is also transmitted by the output unit 24 to the related ground device 18 in the same manner as described above. The ground device 18 that has received the updated flight plan performs flight control of the unmanned aerial vehicle 10 according to the updated flight plan.

Furthermore, the flight management unit 23 may perform the following flight management. That is, in the case of generating the flight plan of the unmanned aerial vehicle, for example, the flight route and the take-off and landing time are adjusted with reference to the flight plan of the unmanned aerial vehicle used in another system so that the unmanned aerial vehicles do not abnormally approach each other or collide with each other.

On the other hand, the emergency flight of the emergency helicopter is a flight in response to the emergency request, and the flight route and the flight time (take-off and landing time) of the emergency helicopter are not planned in advance. Since the emergency flight of the emergency helicopter is prioritized over the flight of the unmanned aerial vehicle 10, it is necessary to change the flight plan of the unmanned aerial vehicle 10 when there is a possibility that the unmanned aerial vehicle 10 obstructs the flight of the emergency helicopter.

That is, when detecting the emergency flight of the emergency helicopter based on the emergency information about the emergency helicopter acquired by the acquisition unit 21, the flight management unit 23 first identifies the unmanned aerial vehicle 10 to be managed flying in the airspace in which the emergency helicopter is flying. For this identification, the position information about the unmanned aerial vehicle 10 acquired by the acquisition unit 21 is used. Regarding the detection of the emergency flight of the emergency helicopter, for example, the flight of the emergency helicopter may be detected using a captured image by a camera transmitted from the unmanned aerial vehicle 10. That is, the fact that the emergency helicopter is captured in the captured image by the camera may be detected using, for example, image analysis or artificial intelligence (AT).

Then, the flight management unit 23 outputs an instruction by the output unit 24 to land the identified unmanned aerial vehicle 10 to the ground device 18 related to the unmanned aerial vehicle 10 in order to evacuate the identified unmanned aerial vehicle from the airspace in which the emergency helicopter is flying. Upon receiving this instruction, the ground device 18 causes the unmanned aerial vehicle 10 to land (evacuate) in accordance with the instruction. Further, when the flight management unit 23 determines that the condition for releasing the unmanned aerial vehicle 10 from the evacuation state is satisfied using, for example, the information related to the flight of the emergency helicopter acquired by the acquisition unit 21, the flight management unit determines that the unmanned aerial vehicle 10 may be released from the evacuation state. The flight management unit 23 calculates the evacuation time during which the unmanned aerial vehicle 10 has been evacuated using, for example, position information and time information associated with the position information. Then, when the calculated evacuation time is longer than the preset time, the flight management unit 23 causes the planning unit 22 to correct the flight plan of the unmanned aerial vehicle 10 whose evacuation has been performed for a long time, and updates the flight plan. The flight plan thus updated is transmitted, by the output unit 24, to the related ground device 18 together with a flight restart instruction. The ground device 18 that has received the updated flight plan performs flight control of the unmanned aerial vehicle 10 according to the updated flight plan.

Furthermore, the flight management unit 23 may perform the following flight management. For example, it is assumed that a sensor (hereinafter, also referred to as a state detection sensor) that detects a state of its own aircraft is included as the sensor 14 mounted on the unmanned aerial vehicle 10. Examples of the state detection sensor include a sensor that detects an abnormality of an electric circuit mounted on the unmanned aerial vehicle 10, and an acceleration sensor that detects a shake of the unmanned aerial vehicle 10. It is assumed that the flight management unit 23 can detect the occurrence of abnormality in the unmanned aerial vehicle 10 by analyzing the sensor output of the state detection sensor acquired by the acquisition unit 21 from the unmanned aerial vehicle 10.

When detecting the unmanned aerial vehicle 10 in which the abnormality occurs, the flight management unit 23 outputs an instruction by the output unit 24 to land to the ground device 18 related to the unmanned aerial vehicle 10. Upon receiving this instruction, the ground device 18 lands the unmanned aerial vehicle 10 in accordance with the instruction. In this case, the flight management unit 23 allocates the article scheduled to be transported by the unmanned aerial vehicle 10 in which the abnormality has occurred to another unmanned aerial vehicle 10 to be managed, and causes the planning unit 22 to correct the flight plan of the unmanned aerial vehicle 10 to which the article has been allocated to update the flight plan. The flight plan thus updated is also transmitted by the output unit 24 to the related ground device 18 in the same manner as described above. The ground device 18 that has received the updated flight plan performs flight control of the unmanned aerial vehicle 10 according to the updated flight plan.

Furthermore, the flight management unit 23 may perform the following flight management. For example, the flight management unit 23 monitors the remaining battery level information acquired by the acquisition unit 21 from the unmanned aerial vehicle 10. Then, it is assumed that the flight management unit 23 detects the unmanned aerial vehicle 10 whose flight plan is required to be reviewed because of the remaining battery level. The unmanned aerial vehicle 10 is, for example, an unmanned aerial vehicle 10 that may run out of battery before the charging timing according to the flight plan in a case where the unmanned aerial vehicle is operated according to the flight plan because the remaining battery level is less than scheduled. In this case, in order to charge the battery 16 of the unmanned aerial vehicle 10, which may run out of battery, earlier than scheduled, the flight management unit 23 causes the planning unit 22 to correct the flight plan of the unmanned aerial vehicle 10 and updates the flight plan. The flight plan thus updated is also transmitted by the output unit 24 to the related ground device 18 in the same manner as described above. The ground device 18 that has received the updated flight plan performs flight control of the unmanned aerial vehicle 10 according to the updated flight plan. The flight management unit 23 may perform the following flight management.

For example, the flight management unit 23 detects the weather condition of the airspace in which the unmanned aerial vehicle 10 is flying using the weather information acquired by the acquisition unit 21 from the information source of the weather information and the sensor output of the sensor 14 related to the weather acquired by the acquisition unit 21 from the unmanned aerial vehicle 10. Then, for example, when the flight management unit 23 detects that the weather condition temporarily deteriorates such as torrential rain or wind gusts in the airspace in which the unmanned aerial vehicle 10 flies, the flight management unit outputs an instruction by the output unit 24 to land (evacuate) to the ground device 18 related to the unmanned aerial vehicle 10 flying in the airspace. Upon receiving this instruction, the ground device 18 lands (evacuates) the unmanned aerial vehicle 10 in accordance with the instruction. Further, the flight management unit 23 determines that the unmanned aerial vehicle 10 may be released from the evacuation state when determining that the condition for releasing the unmanned aerial vehicle 10 from the evacuation state is satisfied, for example, using the weather information acquired by the acquisition unit 21. The flight management unit 23 calculates the evacuation time during which the unmanned aerial vehicle 10 has evacuated, for example, using position information and time information associated with the position information. Then, when the calculated evacuation time is longer than the preset time, the flight management unit 23 causes the planning unit 22 to correct the flight plan of the unmanned aerial vehicle 10 whose evacuation time is long and updates the flight plan. The flight plan thus updated is transmitted, by the output unit 24, to the related ground device 18 together with a flight restart instruction. The ground device 18 that has received the updated flight plan performs flight control of the unmanned aerial vehicle 10 according to the updated flight plan.

The flight management unit 23 manages the flight of the unmanned aerial vehicle 10 to be managed using the aircraft information transmitted from the unmanned aerial vehicle 10 to the centralized management device 2 via the information communication device 3 and information such as position information and sensor output information transmitted at a predetermined timing. The position information and the sensor output information transmitted from the unmanned aerial vehicle 10 are information effective for grasping the flight status of the unmanned aerial vehicle 10. Since the centralized management device 2 can acquire such information through the information communication device 3 every moment at a predetermined timing, the flight management unit 23 can detect the flight status of the unmanned aerial vehicle 10 in real time using the acquired information. Therefore, the flight management unit 23 can perform flight management suitable for the flight status of the unmanned aerial vehicle 10.

Incidentally, in the case of constructing a distribution system, there is a case where a business operator (consignor) constructing the system entrusts transportation (delivery) of articles to a plurality of companies or individual business operators (consignee) possessing or managing the unmanned aerial vehicle. In such a case, the commission calculated using the information about the size and the number of the transported articles is paid from the consignor to the consignee. The centralized management device 2 according to the first example embodiment may include a calculation unit 25 as a function unit that calculates such a commission. When the calculation unit 25 is included in the centralized management device 2, the aircraft consignee information is stored in the storage device 40 of the centralized management device 2 or the database 7. The aircraft consignee information is data in which the consignee and aircraft identification information for identifying the unmanned aerial vehicle 10 owned or managed by the consignee are associated with each other. The storage device 40 of the centralized management device 2 or the database 7 stores data of a fee table for commission calculation to be referred to when calculating a commission to be paid to the consignee. That is, the data of the fee table is the commission calculation data for calculating the commission related to the service content provided to the unmanned aerial vehicle 10.

For example, the calculation unit 25 reads the information about the flight plan stored in the storage device 40 or the database 7 for each aircraft identification information. The read information about the flight plan for each unmanned aerial vehicle 10 can be service history information including information indicating the content of a service executed by each of the unmanned aerial vehicle 10. The calculation unit 25 extracts information about the transported article necessary for calculating the commission from the read flight plan. Then, the calculation unit 25 calculates a commission in a set period such as every day or every month for each aircraft identification information by using the extracted information and the data of the fee table. Further, the calculation unit 25 calculates a commission in a set period for each consignee (in other words, the group to which the unmanned aerial vehicle belongs) by using the calculated commission for each aircraft identification information and the aircraft consignee information. For example, the information about the commission calculated in this manner is output, by the output unit 24, to a destination, of the consignee, registered in advance. The information about the commission may be displayed on a display device (not illustrated) connected to the centralized management device 2.

The centralized management system 1 according to the first example embodiment is configured as described above. The centralized management system 1 can acquire the same type of information in the same data format from each of the unmanned aerial vehicles 10 using the information communication device 3 even when performing flight management of the unmanned aerial vehicles 10 of different types. As a result, the centralized management device 2 can acquire information used for flight management of the unmanned aerial vehicle 10 without performing complicated processing related to information acquisition such as performing processing on the information acquired from the unmanned aerial vehicle 10 for each type of the unmanned aerial vehicle 10. In a case where a new type of the unmanned aerial vehicle is to be used in the system, the centralized management system 1 can eliminate the troublesome work of preparing a program for executing complicated processing related to information acquisition related to the new type of the unmanned aerial vehicle.

### Other Example Embodiments

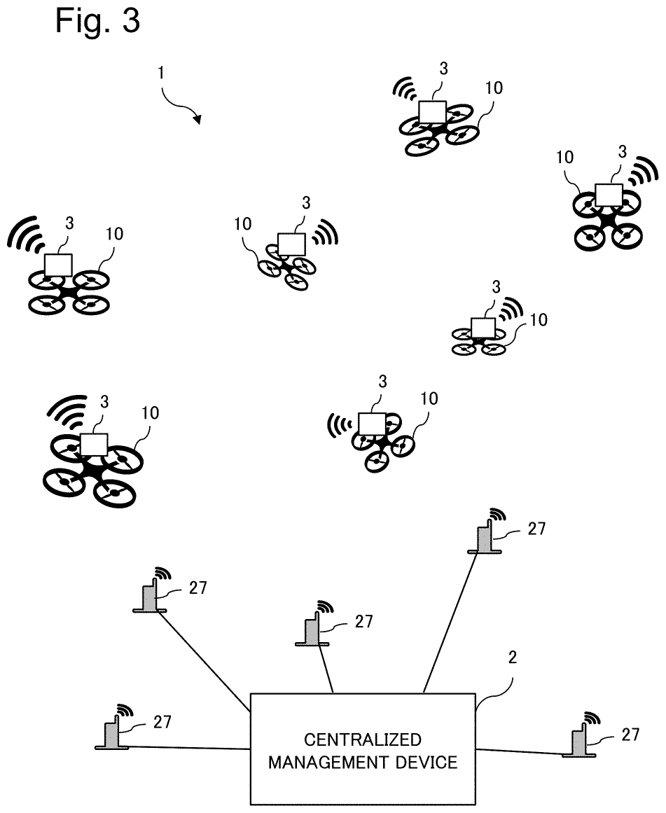

The present invention is not limited to the first example embodiment, and various example embodiments can be used. For example, for communication connection between the information communication device 3 and the centralized management device 2, an information communication network of a mobile terminal may be used, or a reception device 27 as illustrated in FIG. 3 may be used. The reception device 27 is an element constituting the centralized management system 1, and is a device that receives information transmitted from the information communication device 3 by wireless communication to transmit the received information to the centralized management device 2. In the centralized management system 1, a plurality of reception devices 27 is disposed at different locations. The arrangement interval of the reception devices 27 is set in consideration of, for example, the intensity of radio waves for transmitting information output from the information communication device 3.

In the first example embodiment, the centralized management device 2 includes the planning unit 22 and has a function of generating a flight plan of the unmanned aerial vehicle. Instead of this, the flight plan of the unmanned aerial vehicle may be generated by another computer device, and the centralized management device 2 may acquire the generated flight plan and perform the flight management of the unmanned aerial vehicle 10 using the acquired flight plan. In this case, the centralized management device 2 can omit the planning unit 22.

Furthermore, in the first example embodiment, the configuration of the centralized management system 1 is described by taking the flight management of the unmanned aerial vehicle 10 constructing the distribution system as an example. Instead of this, for example, the centralized management system for an unmanned aerial vehicle of the first example embodiment can also be applied to a case of performing the flight management of an unmanned aerial vehicle that constructs a system such as infrastructure inspection other than the distribution.

Furthermore, the information communication device 3 may be equipped with a sensor that collects information indicating the flight status of the unmanned aerial vehicle 10 to which the information communication device is attached, and transmits the sensor output of the sensor to the centralized management device 2. The information communication device 3 may have a function of detecting a radio wave condition around the unmanned aerial vehicle 10 using the intensity of radio wave reception from the centralized management device 2, and may transmit information indicating the radio wave condition around the unmanned aerial vehicle 10 detected by the function to the centralized management device 2. The centralized management device 2 may perform flight management in consideration of such a radio wave condition around the unmanned aerial vehicle 10.

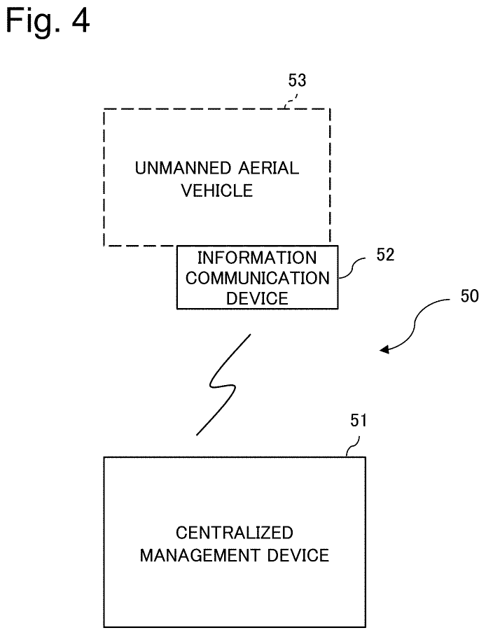

FIG. 4 is a diagram illustrating a minimum configuration of the centralized management system for an unmanned aerial vehicle according to the present invention. A centralized management system 50 for the unmanned aerial vehicle includes a centralized management device 51 and an information communication device 52. The information communication device 52 is attached to an unmanned aerial vehicle 53 to be monitored, acquires flight status information indicating a flight status of the unmanned aerial vehicle 53 from the unmanned aerial vehicle 53, and transmits the acquired flight status information in a predetermined data format by wireless communication. The centralized management device 51 monitors the unmanned aerial vehicle 53 using flight status information indicating a flight status of the unmanned aerial vehicle 53 to be monitored.

That is, in the centralized management system 50 for the unmanned aerial vehicle, the information communication device 52 is attached to the unmanned aerial vehicle 53 to be monitored, and the information communication device 52 acquires the flight status information from the unmanned aerial vehicle 53. The information communication device 52 transmits the acquired flight status information in a predetermined data format by wireless communication. The centralized management device 51 monitors the unmanned aerial vehicle 53 using the flight status information transmitted from the information communication device 52.

In such the centralized management system 50 for the unmanned aerial vehicle and a centralized management method for the unmanned aerial vehicle, even when there is a plurality of unmanned aerial vehicles 53 to be monitored and types, administrators, and the like of the plurality of unmanned aerial vehicles 53 are different from each other, the centralized management device 51 can acquire flight status information in the same data format from the information communication device 52 attached to each of the unmanned aerial vehicles 53. Therefore, even when monitoring a plurality of types of unmanned aerial vehicles 53 different from each other, the centralized management device 51 can prevent complication of processing related to information acquisition from each unmanned aerial vehicle 53.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

1. A centralized management system for an unmanned aerial vehicle comprising:
an information communication device that is attached to an unmanned aerial vehicle to be monitored, acquires flight status information indicating a flight status of the unmanned aerial vehicle from the unmanned aerial vehicle, and transmits the acquired flight status information in a predetermined data format by wireless communication; and
a centralized management device that monitors the unmanned aerial vehicle using the flight status information transmitted from the information communication device.

2. The centralized management system for an unmanned aerial vehicle according to claim 1, wherein
the information communication device acquires the flight status information from the unmanned aerial vehicle at a predetermined timing to transmit the acquired flight status information.

3. The centralized management system for an unmanned aerial vehicle according to claim 1, wherein
the centralized management device acquires, from an information source that provides airspace information indicating a status of an airspace in which the unmanned aerial vehicle flies, the airspace information, and performs flight management of the unmanned aerial vehicle using the acquired airspace information and the flight status information.

4. The centralized management system for an unmanned aerial vehicle according to claim 1, further comprising:
a reception device that receives the flight status information transmitted from the information communication device to transmit the received flight status information to the centralized management device, wherein
a plurality of the reception devices is disposed at different locations.

5. The centralized management system for an unmanned aerial vehicle according to claim 1, wherein
the centralized management device holds service history information including information indicating a content of a service executed by each of the plurality of unmanned aerial vehicles, and wherein
the centralized management device further calculates a commission in a preset period for one or both of each of the unmanned aerial vehicles and each group to which the unmanned aerial vehicles belong by using commission calculation data for calculating a commission related to a content of a service given in advance and the service history information.

6. A centralized management method for an unmanned aerial vehicle, the method comprising:
an information communication device that is attached to an unmanned aerial vehicle to be monitored acquiring flight status information indicating a flight status of the unmanned aerial vehicle from the unmanned aerial vehicle; and
transmitting the acquired flight status information in a predetermined data format by wireless communication; and
a centralized management device that monitors the unmanned aerial vehicle monitoring the unmanned aerial vehicle using the flight status information transmitted from the information communication device.

7. The centralized management method for an unmanned aerial vehicle according to claim 6, wherein
the information communication device acquires the flight status information from the unmanned aerial vehicle at a predetermined timing to transmit the acquired flight status information.

8. The centralized management method for an unmanned aerial vehicle according to claim 6, wherein
the centralized management device acquires, from an information source that provides airspace information indicating a status of an airspace in which the unmanned aerial vehicle flies, the airspace information, and performs flight management of the unmanned aerial vehicle using the acquired airspace information and the flight status information.

9. The centralized management method for an unmanned aerial vehicle according to claim 6, wherein
a plurality of reception devices disposed at different locations receives the flight status information transmitted from the information communication device to transmit the received flight status information to the centralized management device.

10. The centralized management method for an unmanned aerial vehicle according to claim 6, wherein
the centralized management device holds service history information including information indicating a content of a service executed by each of the plurality of unmanned aerial vehicles, and wherein
the centralized management device further calculates a commission in a preset period for one or both of each of the unmanned aerial vehicles and each group to which the unmanned aerial vehicles belong by using commission calculation data for calculating a commission related to a content of a service given in advance and the service history information.
